(19) United States
(12) Patent Application Publication
(10) Pub. No.: US 2007/0019875 A1
(43) Pub. Date: Jan. 25, 2007

(54) Method of further compressing JPEG image

(76) Inventors: Chih-Ta Star Sung, Glonn (DE); Eckebard Steinbach, Olching (DE); Ingo Bauermann, Munchen (DE); Yin-Chun Lan, Wurih Township (TW)

Correspondence Address: Chih-Ta Star SUNG, RM. 308, BLD. 52, NO. 195, CHUNG HSING RD., SEC. 4, CHU TUNG TOWNSHIP, HSINCHU COUNTY, 310, TW

(21) Appl. No.: 11/186,002

(22) Filed: Jul. 21, 2005

(51) Int. Cl. G06K 9/36

(52) U.S. Cl. 382/239

(57) ABSTRACT

Recovered 8×8 DCT coefficient arrays of all block of a JPEG image is formed by reversely decompressing the JPEG image till the procedure of dequantization. A method of redundancy removal of inter-block same subband AC coefficient and intra-block adjacent subband DCT coefficients is applied by re-ordering the coefficients by magnitude of the neighboring subband or a weighted sum of those. The differential values of both inter-block and intra-block DCT coefficients are calculated and coded by an entropy coder to further reduce the data rate. A short code is assigned to represent the “end of non-zero” of each re-ordered subband AC coefficients.

### BACKGROUND OF THE INVENTION

1. Field of Invention

The present invention relates to compression techniques for digital images, and particularly relates to further compression of JPEG compliant encoded images.

2. Description of Related Art

Digital imaging technologies have become popular in mass applications like digital camera, digital camcorder, digital photo albums, scanner/printer/fax, mobile multimedia messaging . . . . One of the most popular still image compression standard is the JPEG, which is a still picture compression standard designed by the Joint Picture Expert Group with ITU.

Further compressing the JPEG image implies that the cost of storage and the time of transmitting image can be reduced.

One of the well know prior art of further compressing JPEG image is recovering the JPEG picture to the de-quantized DCT coefficients and further quantize the DCT coefficients again before other procedures similar to the JPEG compression steps, which degrades the image quality or can not achieve the goal of data rate reduction if not degrades the image quality.

The method and apparatus of this invention of further compressing JPEG image reduces the JPEG data rate without sacrificing the image quality.

### SUMMARY OF THE INVENTION

The present invention of further compressing the JPEG image, said the compressed image data through some procedures of recovering the image and recompressing the image by some reliable alternatives.

The present invention of further compressing the JPEG image firstly decompresses the JPEG image by regular procedures till the de-qualtization and further compress the image.

According to an embodiment of this invention of further compressing the JPEG image, the recovered DCT coefficients are re-compressed by removing the redundancy of inter-block and intra-block similarity.

According to an embodiment of this invention of further compressing the JPEG image, re-ordering the AC coefficients follow the magnitude of the next neighboring frequency AC coefficients.

According to another embodiment of this invention of further compressing the JPEG image, the re-ordered AC coefficients are compressed by either inter-block of same subband or intra-block adjacent subband, and the one with shorter code is selected.

According to an embodiment of this invention of further compressing the JPEG image, a code named “End-Of Block” (EOB) is applied to represent “No non-zero” of the re-ordered AC coefficients.

According to an embodiment of this invention of further compressing the JPEG image, groups of coefficients with similar statistics are produced to exploit intra-block and inter-block redundancy at the same time.

According to an embodiment of the coding the DCT coefficients, the differential values of the magnitude between re-ordered blocks in inter-block mode or adjacent subband of intra-block are calculated for VLC coding.

According to an embodiment of the VLC coding algorithm of the differential values of the present invention of DCT coefficients, only the “Quotient” and “Remainder” are coded with the “Divider” implicitly done by prediction.

According to another embodiment of this invention of further compressing the JPEG image, a lossy algorithm with quantization is optionally applied to achieve higher compression rate with a little sacrifice of image quality.

Other aspects and advantages of the present invention will become apparent from the following detailed description, taken in conjunction with the accompanying drawings, illustrating by way of example the principles of the invention. It is to be understood that both the foregoing general description and the following detailed description are by examples, and are intended to provide further explanation of the invention as claimed.

### BRIEF DESCRIPTION OF THE DRAWINGS

FIG. 1 depicts the procedure of the JPEG still image compression.

FIG. 2 depicts the procedure of the JPEG still image decompression.

FIG. 3 illustrates a known prior art of procedure of further compressing the JPEG image.

FIG. 4 illustrates a preferred embodiment according to the invention of further compressing the JPEG image

FIG. 5 shows a table listing all DCT coefficients in an order of raster block number with the same subband in the same column.

FIG. 6 shows a table listing all DCT coefficients in an order according to the magnitude of AC1 coefficient and other subband following the same order of AC1

FIG. 7 shows a table of inserted the code of “end-of-block” into represent “no more non-zero coefficient” of each subband of coefficient.

FIG. 8 illustrates the procedure of further compressing JPEG image with lossy and lossless algorithms.

### DESCRIPTION OF THE PREFERRED EMBODIMENTS

ITU has developed and defined some image and video compression algorithms including JPEG, an still image compression standard. JPEG image has widely applications including but not limited to digital camera, scanner/printer, digital photo albums, scanner/printer/fax, mobile multimedia messaging, internet media, web site design, . . . . Reducing data rate of JPEG image has benefit of

1. Saving the memory density and cost in storage

2. Reducing requirement of bandwidth in data transmission

The later also means saving time in data transmission in wired or wireless transmission.

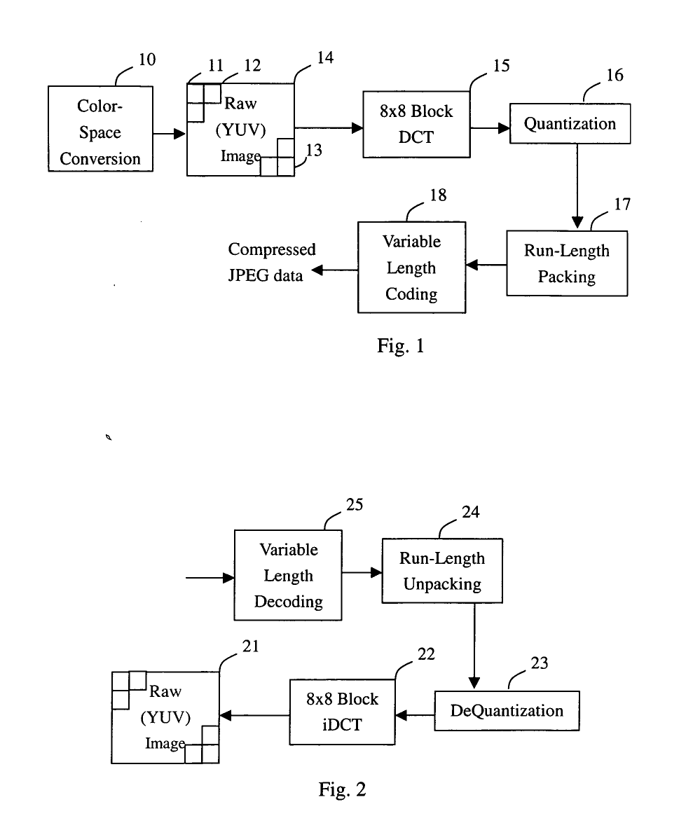

JPEG image compression as shown in FIG. 1 includes some procedures in compression. An image 14 is partitioned into many units of so named “Block” of 8×8 pixels to run the JPEG compression. A color space conversion 10 mechanism transfers each 8×8 block pixels of the R(Red), G(Green), B(Blue) components into Y(Luminance), U(Chrominance), V(Chrominance) and further shifts them to Y, Cb and Cr. JPEG compresses 8×8 block of Y, Cb, Cr 11, 12, 13 by the following procedures:

Step1: Discrete Cosine Transform (DCT), Step 2: Quantization Step 3: Zig-Zag scanning, Step 4: Run-Length pair packing and Step 5: Variable length coding (VLC).

DCT 15 converts the time domain pixel values into frequency domain. After transform, the DCT “Coefficients” with a total of 64 subbabd of frequency represent the block image data, no long represent single pixel. The 8×8 DCT coefficients form the 2-dimention array with lower frequency accumulated in the left top corner, the farer away from the left top, the higher frequency will be. Further on, the more closer to the left top , the more DC frequency which dominates the more information. The more right bottom coefficient represents the higher frequency which less important in dominance of the information. Like filtering, quantization 16 of the DCT coefficient is to divide the 8×8 DCT coefficients and to round to predetermined values. Most commonly used quantization table will have larger steps for right bottom DCT coefficients and smaller steps for coefficients in more left top corner. Quantization is the only step in JPEG compression causing data loss.

After quantization, most DCT coefficient in the right bottom direction will be rounded to “0s” and only a few in the left top corner are still left non-zero which allows another step of said “Zig-Zag” scanning and Run-Length packing 17 which starts left top DC coefficient and following the zig-zag direction of scanning higher frequency coefficients. The Run-Length pair means the number of “Runs of continuous 0s”, and value of the following non-zero coefficient.

The Run-Length pair is sent to the so called “Variable Length Coding” 18 (VLC) which is an entropy coding method. The entropy coding is a statistical coding which uses shorter bits to represent more frequent happen patter and longer code to represent the less frequent happened pattern. The JPEG standard accepts “Huffman” coding algorithm as the entropy coding. VLC is a step of lossless compression.

The JPEG compression procedures are reversible, which means following the backward procedures, one can decompresses and recovers the JPEG image back to raw and uncompressed YUV (or further on RGB) pixels as shown in FIG. 2. A variable length decoding (VLD) 25 decodes the variable length code and sent it to be unpacked 24 in in the form of “Run-Length” pair. Till this point, the 8×8 block DCT coefficients are formed. The next step is to de-quantize 23 the 8×8 coefficient by multiplying value set in the quantization table. The last step of inverse DCT (iDCT) 22 transforms the frequency domain coefficient to time domain values of 8×8 pixels. All Y, U and V components are following the same procedures of compression and decompression in JPEG compression. After decompressing the Y/U/V three components, the original picture 21 can be recovered in a form of YUV or RGB.

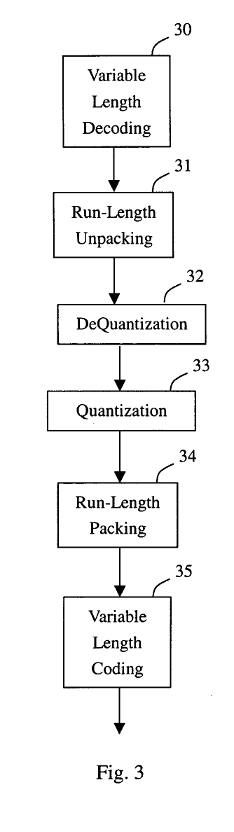

Since all steps in JPEG compression are lossless procedures except for quantization and the Huffman coding table is fixed, for reducing the data rate of JPEG image, most known prior arts are recovering the JPEG image to the dequantization of DCT coefficients as shown in FIG. 3 which including a variable length decoding 30, Run-Length unpacking 31, dequantization 32. And then re-quantize the DCT coefficients 33 by applying larger quantization step. Other steps like Run-Length packing 34 and Variable Length decoding, VLD 35 are the same like JPEG compression. This kind of mechanism of reducing JPEG image data has fundamentally disadvantage of degrading the image quality.

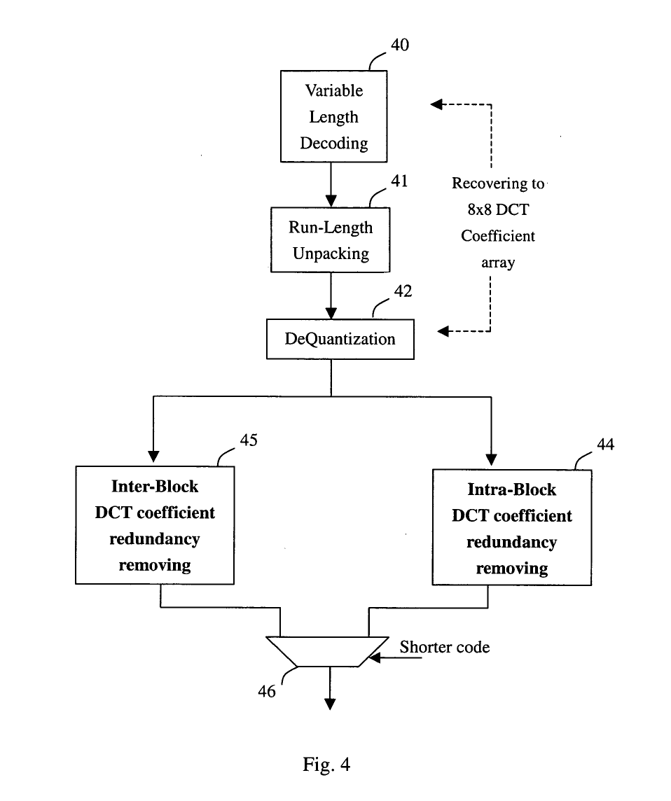

To avoid degrading image quality and still achieve data rate reduction of JPEG image, instead of “re-quantization” in most prior arts method, this invention of further JPEG image compression takes complete new mechanisms in removing redundancy of DCT coefficients. FIG. 4 illustrates the flow chart of procedure of this invention of further compressing JPEG image. The JPEG image are recovered by the first three steps similar to other alternative including the Variable Length Decoding, VLD 40, Run-Length unpacking 41 and dequantiztion 42. Till the point of dequantization, the 8×8 DCT coefficient array is recovered. Further compressing the JPEG image starts from this point.

There are two main algorithms of removing the redundancy of DCT coefficients, the first mechanism is removing redundancy of the same subband or said frequency between adjacent blocks, and the 2^{nd} mechanism is removing the redundancy of the adjacent subband or said frequency within the same block of DCT coefficients. As shown in FIG. 4, the 8×8 DCT coefficients of all blocks of an JPEG image have been recovered and goes through the procedure of the intra-block DCT coefficient redundancy removing 44 and inter-block DCT coefficient redundancy removing 45. The results of the redundancy removal of the DCT coefficients will be compared. The one of shorter code 46 will be selected through a multiplexer to be the output of the further compressing JPEG image.

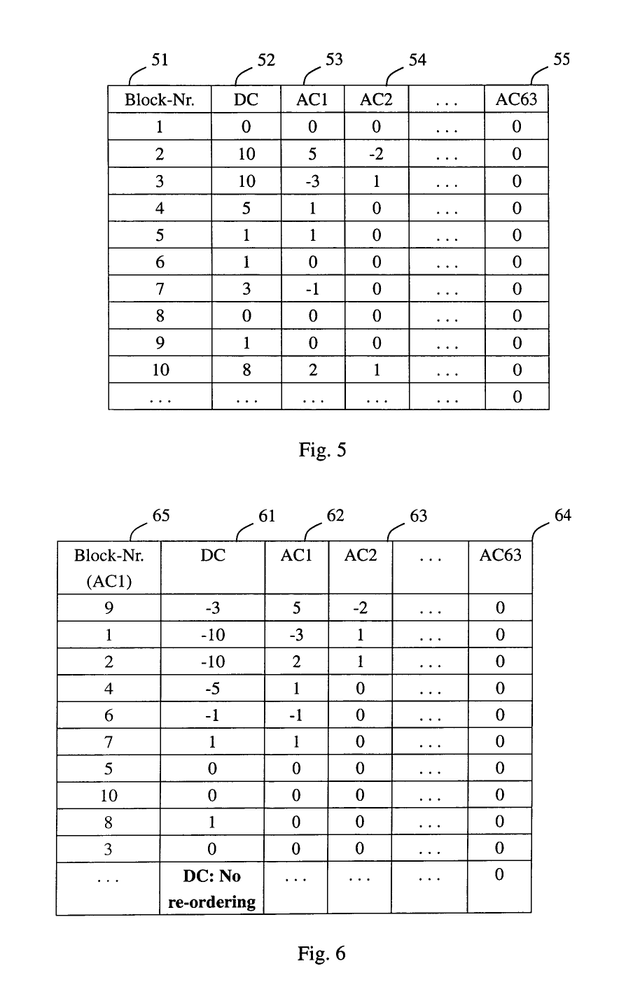

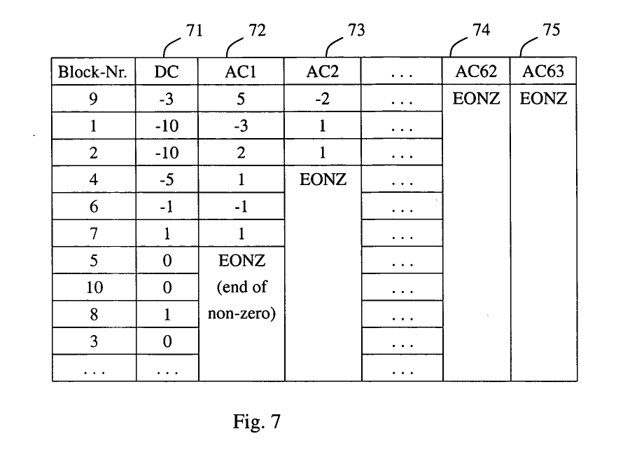

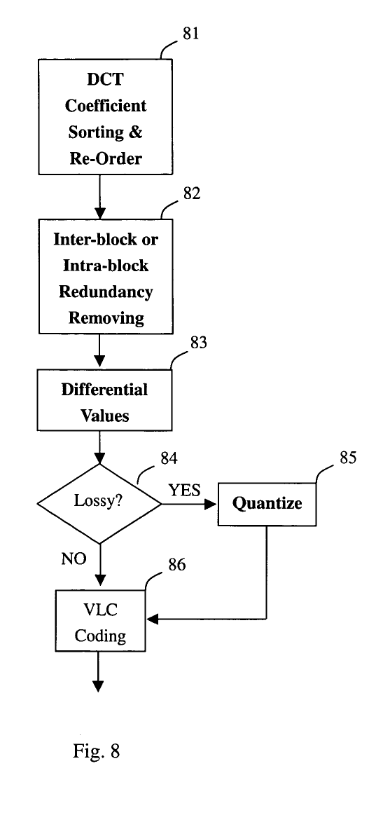

In the present invention of further compressing JPEG image, in practical implementation, to further reduce the data rate, the recovered DCT coefficient arrays of all blocks as shown are re-organized and re-coded by new algorithms. FIG. 5 lists examples of all blocks DCT coefficient of a popular test bench, “Lena” with mid- degree of quantization. DCT coefficients of all blocks of the same subband are put together in the same column. Column 1 lists block number 51, column 2 lists all DC coefficient 52, column 3 lists all AC1 coefficients 53, column 4 lists all AC1 coefficients 54 . . . . All AC63 coefficients are put in the last column 55.

All blocks of AC DCT coefficient arrays, for example, the AC1 are sorted and re-ordered by the magnitude of their left neighbor. The order of all block's AC coefficients is used as the reference for the corresponding AC coefficients to its right. FIG. 6 illustrates the re-ordered DCT coefficients of all block of the test bench “Lena”. Similar to original JPEG compression, all DC coefficients 61 are then coded by predictive mode which is to code the differential values between adjacent blocks. Column 1 shows the block number of re-ordered blocks for the first AC coefficient 65. Column 3 lists all AC1 coefficients 62 according to the re-ordered block number. Column 4 lists all re-ordered AC2 coefficient 63. It is expected that all AC63 coefficients 64 are “0s” since AC63 is highest frequency. From the re-ordered AC coefficients, it is obvious that there is high possibility that the higher the frequency, the higher number of coefficients will become “0s” 74, 75. In the case of “no more non-zero”, a short code of “00” is assigned to represent “end-of-non-zero (EONZ)” which shows up in every AC frequency. The AC1 column 72 shows that there are 6 non-zero coefficients. While, there are 3 non-zero coefficients in AC2 column 73. Inserting the EONZ (“00”) makes the coding efficiency higher. Alternatively, an EONZ in horizontal direction, along the coefficient number can be inserted.

Since all 63 AC coefficients are sorted, in the intra-block DCT coefficient coding, the differential value between adjacent subband, AC1-AC2-AC3 . . . -AC62-AC63 are calculated and coded by a VLC coding. While, in the inter-block DCT coefficient coding, the differential values between the re-ordered coefficients according to the magnitude will be coded by another VLC coding. The result of the inter-block and intra-block coding are examined to determine that the one with shorter code will be selected as the output of the new bit stream.

The differential values between re-ordered blocks in inter-block mode or adjacent subband of intra-block are calculated for VLC coding. The calculated difference is coded by the following equation:
D_{—}n=Q×M+R (Q: Quotient, M: Divider, R: Remainder) Eq. (1)
the “Quotient” and “Remainder” are coded with the “Divider” implicitly done by prediction. For example: 12=2×5+2
In the VLC coding of this invention, the Y=1 and R=2 are the only two parameters needed to be coded with the M=5 implicitly predicted by an average of weighted factors times Ms of previous pixels. 1^{st} step of the VLC coding is to predict the value of M, the divider. Eq. (2) illustrates the means of predicting the value of M.
M_{—}n=(Mn−1+D_{—}n)/2 Eq. (2)

As one can see that the Dn of the closest previous value has highest weight like ½, the next closest value will have a factor of ¼, . . . etc. the farer the differential value, the lower value the weighted factors and less influence to the present pixel in predicting the M.

An optional method of coding the differential values is adaptively applying an arithmetic coding for coding the differential values of the inter-block and intra-block DCT coefficients.

Sacrificing a little image quality will be able to further reduce the data rate of the JPEG image. The recovered DCT coefficients are sorted and re-ordered 81 to form a status which is easier for removing the redundancy 82 of DCT coefficients. If a lossy algorithm is determined, then the differential values 83 of inter-block same subband and the differential values of intra-block adjacent subband DCT coefficients are quantized 85 and coded by a VLC coding 86, if not lossy algorithm, then not going through the quantization step and the differential values are coded by VLC coding. During quantizing the differential values, a mechanism rounds the DCT coefficients to predetermined values. An entropy coding of adaptively using arithmetic coding is applied to achieve higher compression rate of further compressing the JPEG image.

Color components, U and V or Cr and Cb also follow the same procedure to further compress the JPE image. Since human being's vision is less sensitive to color than brightness, in quantizing the chroma, U/V (or Cb/Cr), larger quantization step is applied to chroma.

It will be apparent to those skills in the art that various modifications and variations can be made to the structure of the present invention without departing from the scope or the spirit of the invention. In the view of the foregoing, it is intended that the present invention cover modifications and variations of this invention provided they fall within the scope of the following claims and their equivalents.

What is claimed is:

1. A method of further compressing JPEG image, comprising:
recovering at least two blocks of DCT coefficients of JPEG image by procedure of decompression procedure of “variable length decoding”, “run-length unpacking”, “zig-zag scanning” and “de-quanitzation”;
removing inter-block or intra-block redundancy of the recovered DCT coefficients of block image; and
variable length encoding of the selected DCT coefficients from inter-block or intra-block of each block of image.

2. The method of claim 1, wherein the recovering procedure includes the variable length decoding, Run-Length unpacking and dequantization to form an array of 8×8 DCT coefficients.

3. The method of claim 1, wherein the recovered DCT coefficients are saved in a temporary buffer and form 8×8 DCT coefficient arrays.

4. The method of claim 1, wherein in removing redundancy of the DCT coefficients, differential values of inter-block same subband DCT coefficients are calculated and coded by a VLC coding.

5. The method of claim 1, wherein in removing redundancy of the DCT coefficients, differential values of intra-block adjacent subband DCT coefficients are calculated and coded by a VLC coding.

6. The method of claim 1, wherein the color components, U/V or Cb/Cr follow the same compression procedure of Y in further compressing JPEG image.

7. A method of removing redundancy of DCT coefficients, comprising re-ordering the DCT coefficient of the AC coefficients according to the magnitude of DCT coefficients of the neighboring frequency;
calculating the differential values of inter-block AC coefficients and intra-block AC coefficients;
coding the differential values of inter-block AC coefficients and intra-block AC coefficients by using variable length coding; and
selecting the shorter code of inter-block and intra-block coding to represent the result of the coding.

8. Method of claim 7, wherein re-ordering the AC coefficients, the neighboring frequency is the next lower or the next higher frequency.

9. Method of claim 7, wherein assigning a shorter code to represent “end of non-zero” status where the non-zero coefficient starts.

10. Method of claim 7, wherein during VLC coding of the differential values of the inter-block or intra-block DCT coefficients, only the “Quotient” and “Remainder” are coded with the “Divider” implicitly done by prediction.

11. Method of claim 10, wherein the “Divider” is calculated by taking average of adjacent weighted differential values of DCT coefficients with closer having heavier weight and farer less weight.

12. Method of claim 7, wherein adaptively applying an arithmetic coding for coding the differential values of the inter-block and intra-block DCT coefficients.

13. An apparatus of further compressing JPEG image, comprising
an decompression engine recovering the JPEG image to dequantization step and forming the 8×8 DCT coefficient array;
an device re-ordering the DCT coefficient of the AC coefficients according to the magnitude of the neighboring frequency DCT coefficient;
an engine calculating the differential values of inter-block AC coefficients and intra-block AC coefficients and selecting the one with smaller value for VLC coding;
a calculating unit quantizing the differential values of the inter-block and intra-block coefficients; and
a compression unit coding the differential values of inter-block AC coefficients and intra-block AC coefficients by using a variable length code;

14. Apparatus of claim 13, wherein the color components, U/V or Cb/Cr follow the same compression procedure of Y in further compressing JPEG image.

15. Apparatus of claim 13, wherein during quantizing the differential values of inter-block or intra-block DCT coefficients, the quantization step is minimized to avoid degrading the image quality.

16. Apparatus of claim 13, wherein the color components, U/V or Cb/Cr follow the same compression procedure of Y with larger quantization step.

17. The apparatus of claim 13, wherein a certain amount of the re-ordered differences of adjacent pixels are left with no compression operation.
